(19) United States
(12) Patent Application Publication
(10) Pub. No.: US 2008/0232500 A1
(43) Pub. Date: Sep. 25, 2008

(54) Soft Output Sphere Decoding Method

(75) Inventors: Jong-Ee Oh, Daejeon (KR); Dong-seung Kwon, Daejeon (KR)

Correspondence Address: CANTOR COLBURN, LLP, 20 Church Street, 22nd Floor, Hartford, CT, 06103, US

(73) Assignee: Eletronics and Telecommunications Research Intitute, Daejeon (KR)

(21) Appl. No.: 11/917,805

(22) PCT Filed: Dec. 26, 2005
(86) PCT No.: PCT/KR2005/004549

§ 371 Date: Dec. 17, 2007

(30) Foreign Application Priority Data
Jun. 16, 2005 (KR) 10-2005-0051848

(51) Int. Cl. H04L 5/12

(52) U.S. Cl. 375/262; 375/260

(57) ABSTRACT

Provided is a soft output sphere decoding method for a MIMO system. The soft output sphere decoding method includes the steps of: detecting a maximum likelihood symbol nearest to a receiving signal; calculating a lattice point nearest to the receiving signal and having a symbol bit opposite to the detected maximum likelihood symbol for all bits of the receiving signal; and calculating a ratio between a distance from the receiving signal to the detected maximum likelihood symbol and a distance from the receiving signal to the calculated lattice points for each bit.

### TECHNICAL FIELD

The present invention relates to a soft output sphere decoding method; and more particularly, to a soft output sphere decoding method based on a space-time code for simultaneously obtaining a spatial multiplexing gain and a diversity gain of a receiver in a multiple input multiple output (MIMO) system capable of increasing a transmission capacity using a plurality of antenna in a transceiver in a wireless communication environment.

### BACKGROUND ART

There is greater demand for various multimedia and high-quality communication services according to popularization of information communication service. In order to provide such various multimedia and high-quality communication services, a transmission capacity of communication system must be enhanced. Such a request pressurizes a wireless communication field harder than a wired communication field to develop related technologies to enhance the performance of the communication system. It is because a usable frequency resource for the wireless communication is limited and the demand of wireless communication has been dramatically increased.

The communication capacity in the wireless communication environment may increases by finding a new usable frequency band or improving the usability and efficiency of the resources. As a method of improving the usability and efficiency of the resources, a technology of using a plurality of antennas in a transmitter and a receiver was introduced. The technology of using a plurality of antennas is a space-time code based technology to improve the reliability of communication link through diversity gain without widening a bandwidth or to increase a transmission capacity through a parallel transmission scheme based on a spatial multiplexing.

The transmission capacity of wireless communication system may increase significantly by using a multiple input multiple output (MIMO) technology. Such a conventional technology is disclosed by Alamouti in an article entitled A simple transmit diversity technique for wireless communication IEEE JSAC, vol. 16, no. 8, Oct. 1998. The Alamouti's technique is a representative transmission diversity technique that overcomes a fading in a wireless channel using a plurality of antennas in a transmitter and a receiver.

The Alamouti's technique is a transmission technique using two transmission antennas providing a diversity order as high as the multiplication of the number of transmitting antenna and the number of the receiving antenna. Accordingly, the maximum diversity gain can be obtained using the Alamouti's technique.

Although the Alamouti's technique is capable of maximum likelihood detection through a simple signal processing in a receiving end, the number of transmission antennas is limited by two. Since only two data symbols are transmitted in two time slots through two transmission antennas, the transmit rate is 1. Therefore, a spatial multiplexing gain cannot be obtained without regarding to the number of receiving antennas.

As a conventional technique of obtaining the spatial multiplexing gain, a vertical Bell laboratories layered space-time (V-BLAST) system was introduced by Bell Lab in an article entitled Detection algorithm and initial laboratory results using V-BLAST space time communication architecture, IEEE Vol. 35, No. 1, pp, 14 to 16, 1999.

In the V-BLAST system, a transmitter simultaneously transmits different signals through each of transmission antennas with a same transmission power and a same transmit rate and a receiver detects a transmitting signal by operations of detection ordering, interference nulling and interference cancellation to eliminate interference signals and to increase a signal-to-noise ratio. Such a method can maximize and maintain the spatial multiplexing gain because the transmitter can simultaneously transmit independent data signals as many as the number of transmission antennas if the V-BLAST system has receiving antennas more than or equal to the transmitting antennas. However, the V-BLAST system has a degraded performance compared to the maximum likelihood detection.

For example, a V-BLAST system using M transmission antennas and 2^{Q}-QAM signal constellations may transmit M×Q bits per each channel use. Herein, 2^{MxQ} lattice points and a distance to a receiving signal must be calculated in order to calculate a soft output value of a bit reliability using the maximum likelihood detection. The complexity greatly increases because the calculation times of distances exponentially increases in proportional to the number transmission bits per a channel use as shown in Table. 1.

TABLE 1

| Number of- | | | |
|---|---|---|---|
| transmission | Modulation | Transmissionbits | Times of calculating |
| antennas | scheme | perchannel use | distances |
| 2 | QPSK | 4 bits/psu | 16 |
| 2 | 16QAM | 8 bits/psu | 256 |
| 2 | 64QAM | 12 bits/psu | 4,096 |
| 4 | QPSK | 8 bits/psu | 256 |
| 4 | 16QAM | 16 bits/psu | 65,536 |
| 4 | 64QAM | 24 bits/psu | 16,777,216 |
| 8 | QPSK | 16 bits/psu | 65,536 |
| 8 | 16QAM | 32 bits/psu | 4,294,967,296 |
| 8 | 64QAM | 48 bits/psu | 281,474,976,710,656 |

As a conventional detection technique having less complexity while having similar performance to the Alamouti technique, a sphere decoding method was introduced in an article entitled On Maximum-Likelihood detection and the search for the closest lattice point IEEE Trans. Information Theory, Vol. 49, No. 10, pp.2389-2402, 2003. The sphere decoding method is effective for hard output detection. By applying such a sphere decoding method to each bit, one lattice point giving highest bit reliability may be detected. However, if the sphere decoding method is applied to each of transmitted bits, the complexity of calculating distances for lattice points increase seriously in order to obtaining the reliability of bits. That is, all points of lattice figure must be searched or numerous distances between the receiving signal and the lattice points must be calculated to find a lattice point having 0 or 1 as a corresponding bit and nearest to the receiving signal.

### DISCLOSURE OF INVENTION

### Technical Problem

It is, therefore, an object of the present invention to provide a soft output sphere decoding method for simply obtaining a bit reliability through a soft output by calculating lattice points having a symbol opposite to a maximum likelihood symbol and nearest to a receiving signal for all bits of the receiving signal.

It is another object of the present invention to provide a soft output sphere decoding method for simply obtaining a bit reliability through a soft output by calculating lattice points nearest to a receiving signal and having predetermined symbol bits same to a maximum likelihood symbol and having remained symbol bits opposite to the maximum likelihood symbol for all bits of the receiving signal.

### Technical Solution

In accordance with one aspect of the present invention, there is provided a soft output sphere coding method in a multiple input multiple output (MIMO) system including the steps of: detecting a maximum likelihood symbol nearest to a receiving signal; calculating lattice points nearest to the receiving signal and having a symbol bit opposite to the detected maximum likelihood symbol for all bits of the receiving signal; and calculating a ratio between a distance from the receiving signal to the detected maximum likelihood symbol and a distance from the receiving signal to the calculated lattice points for each bit.

In accordance with another aspect of the present invention, there is provided a soft output sphere coding method in a multiple input multiple output (MIMO) system including the steps of: detecting a maximum likelihood symbol nearest to a receiving signal; calculating lattice points nearest to the receiving signal and having predetermined symbol bits identical to the detected maximum likelihood symbol and remained symbol bits opposite to the detected maximum likelihood symbol for all bits of the receiving signal; and calculating a ratio between a distance from the receiving signal to the detected maximum likelihood symbol and a distance from the receiving signal to the calculated lattice points for each bit.

### Advantageous Effects

The soft output sphere decoding method according to the present invention effectively estimates soft output values per a transmit bit in a MIMO system. Accordingly, the complexity is reduced and the performance is improved as much as about 2 to 3 dB compared to a hard output decoding method.

### BRIEF DESCRIPTION OF THE DRAWINGS

The above and other objects and features of the present invention will become apparent from the following description of the preferred embodiments given in conjunction with the accompanying drawings, in which:

FIG. 1 is a soft output sphere decoding method in accordance with a preferred embodiment of the present invention; and

FIG. 2 is a soft output sphere decoding method in accordance with another embodiment of the present invention

### BEST MODE FOR CARRYING OUT THE INVENTION

Other objects and aspects of the invention will become apparent from the following description of the embodiments with reference to the accompanying drawings, which is set forth hereinafter.

Hereinafter, the present invention will be described using a multiple input multiple output (MIMO) spatial multiplexing scheme using m transmission antennas and n receiving antennas as an example.

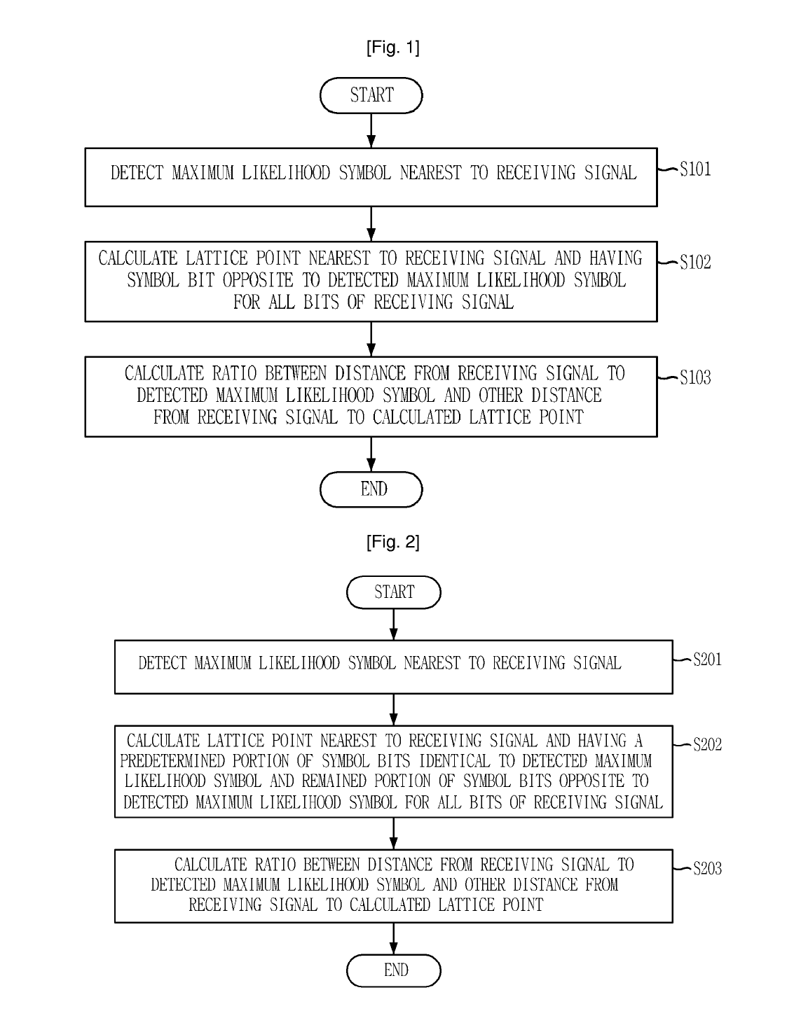

FIG. 1 is a flowchart of a soft output sphere decoding method in accordance with a preferred embodiment of the present invention.

As shown in FIG. 1, a maximum likelihood symbol nearest to a receiving signal is obtained using a conventional sphere coding algorithm at step S101.

That is, a complex number receiving signal received through a receiving antenna can be expressed as a following

$${r}^{c} = \sqrt{\frac{ρ}{m}} {H}^{c} {s}^{c} + {w}^{c} \qquad MathFigure 1$$

Herein, H denotes an n×m channel matrix. h^{C} denotes a (i, j)^{th} element in a matrix H^{C}, and the h^{C} denotes a complex number fading gain from a j^{th} transmitting antenna to an i^{th} receiving antenna. S^{c} is a transmitting signal and W^{c} represents a Gaussian noise vector. If E[s^{c}s^{cH}]=I and E[|h^{c}_{i, j}|²]=1, ρ denotes a signal to nose ratio (SNR).

If U is a set of Q²-QAM transmitting signals having Q² signal points, the simplest spatial multiplexing is a case of directly transmitting a QAM signal through each of antennas. In this case, Eq. 1 can be expressed as following Eq. 2.

$$[ \begin{matrix}Re \{ {r}^{c} \} \\ Im \{ {r}^{c} \}\end{matrix} ] = \sqrt{\frac{12 ρ}{m ( {Q}^{2} - 1 )}} \cdot [ \begin{matrix}Re \{ {H}^{c} \} & - Im \{ {H}^{c} \} \\ Im \{ {H}^{c} \} & Re \{ {H}^{c} \}\end{matrix} ] \cdot [ \begin{matrix}Re \{ {u}^{c} \} \\ Im \{ {u}^{c} \}\end{matrix} ] + [ \begin{matrix}Re \{ {w}^{c} \} \\ Im \{ {w}^{c} \}\end{matrix} ] \qquad MathFigure 2$$

In Eq. 2, Re{u^{c}} and Im{u^{c}} are included in a set of pulse amplitude modulation (PAM) transmitting signals each of which having a size of Q, and the set X is {u=2q−Q+1:qεZ} where Z={0, 1, . . . Q−1}.

Then, the receiving signal is processed through an optimal ordering and QR decomposition, and the processed receiving signal can be expressed as following Eq. 3.

$$r = \sqrt{\frac{12 ρ}{m ( {Q}^{2} - 1 )}} {HPP}^{T} u + w = \sqrt{\frac{12 ρ}{m ( {Q}^{2} - 1 )}} {H}^{′} {u}^{′} + w \\ r = \sqrt{\frac{12 ρ}{m ( {Q}^{2} - 1 )}} \cdot [ \begin{matrix}{Q}_{1} & {Q}_{2}\end{matrix} ] \cdot [ \begin{matrix}R \\ {0}_{( n - m ) \times m}\end{matrix} ] \cdot {u}^{′} + w \\ [ \begin{matrix}{Q}_{1}^{T} \\ {Q}_{2}^{T}\end{matrix} ] \cdot r = \sqrt{\frac{12 ρ}{m ( {Q}^{2} - 1 )}} \cdot [ \begin{matrix}R \\ {0}_{( n - m ) \times m}\end{matrix} ] \cdot {u}^{′} + w \qquad MathFigure 3$$

Herein, P denotes a switch matrix for rearranging an optimal order, [Q₁, Q₂] represents a unitary matrix and R denotes an upper triangular matrix.

Then, it finds a maximum likelihood symbol u that minimizes a square of distance d² to the received signal. It can be expressed as following Eq. 4.

$${d}^{2} = {‖ [ \begin{matrix}{Q}_{1}^{T} \\ {Q}_{2}^{T}\end{matrix} ] \cdot r - \sqrt{\frac{12 ρ}{m ( {Q}^{2} - 1 )}} \cdot [ \begin{matrix}R \\ {0}_{( n - m ) \times m}\end{matrix} ] \cdot {u}^{′} ‖}^{2} = {‖ {Q}_{1}^{T} \cdot r - \sqrt{\frac{12 ρ}{m ( {Q}^{2} - 1 )}} \cdot R \cdot {u}^{′} ‖}^{2} + {‖ {Q}_{2}^{T} \cdot R ‖}^{2} \qquad MathFigure 4$$

If Eq. 4 is simplified by Q^{T}₁·r−>r, R−>H, and u′−>u, Eq. 4 can be expressed as following Eq. 5.

$${‖ r - \sqrt{\frac{12 ρ}{m ( {Q}^{2} - 1 )}} \cdot H \cdot u ‖}^{2} \qquad MathFigure 5$$

Hereinafter, the sphere code algorithm that finds the maximum likelihood symbol u minimizing a square of distance d² from the transmitting signal set X will be described. In order to describe, following decoding method is used.

$$u = [ \begin{matrix}{u}_{1} \\ {u}_{2} \\ ⋮ \\ {u}_{m}\end{matrix} ] , H = [ \begin{matrix}{h}_{11} & {h}_{12} & ⋯ & {h}_{1 m} \\ 0 & {h}_{22} & ⋯ & {h}_{2 m} \\ ⋮ & ⋰ & ⋰ & ⋮ \\ 0 & ⋯ & 0 & {h}_{mm}\end{matrix} ] , {e}_{k} = [ \begin{matrix}{e}_{k 1} \\ {e}_{k 2} \\ ⋮ \\ {e}_{kk}\end{matrix} ] for k = 1 , … , m$$

Herein, uₖεX={u=21−Q+1:qεZ_{Q}} and Z_{Q}=(0, 1, . . . , Q−1}. If z=0, sgn*(z) is −1, and if z>0, sgn*(z) is 1. Also, if x= [symbol] y [symbol] ₓ denotes a point nearest to y while satisfying xεX.

A Schnorr-Euchner scheme that is a modification of a Pohst method can be expressed as a following first algorithm 1 by using the decoding method.

The first algorithm 1 receives a m×m upper triangular matrix H and m-order vectors rεR^{m}, and outputs a m-order vector ûεX^{m} which is lattice point nearest to r.

1. m = order of H
2. bestdist(shortest distance) = 8
3. k=m
4. distₘ (m^{th} distance)= 0
5. eₘ=r
6. uₘ= [symbol] eₘₘ/hₘₘ [symbol] ₓ
7. y=eₘ − hₘₘuₘ
8. stepₘ = 2sgn*(y)
9. <loop>
10. newdist = distₖ + y²
11. if newdist < bestdist and uₘ ∈ X then {
12. if k≠1 then {
13. e_{k-1,i}=eₖᵢ − hᵢₖuₖ for i=1,...k−1
14. k=k−1
15. distₖ = newdist
16. uₖ= [symbol] eₖₖ/hₖₖ [symbol] ₓ
17. y=eₖₖ − hₖₖuₖ
18. stepₖ = 2sgn*(y)
19. } else {
20. u\hat{ }=u
21. bestdist = newdist
22. k=k+1
23. uₖ = uₖ + stepₖ
24. y=eₖₖ − hₖₖuₖ
25. stepₖ = −stepₖ + 2sgn*(stepₖ)
26. }
27. } else if newdist < bestdist then {
28. uₖ = uₖ + stepₖ
29. y=eₖₖ − hₖₖuₖ
30. stepₖ = −setpₖ + 2sgn*(stepₖ)
31. } else {
32. if k=n then return u\hat{ }(and exit)
33. else {
34. k=k+1
35. uₖ = uₖ + stepₖ
36. y=eₖₖ − hₖₖuₖ
37. stepₖ = −stepₖ + 2sgn*(stepₖ)
38. }
39. }
40. goto <loop>

The first algorithm 1 outputs a transmission symbol û which is a maximum likelihood symbol that minimizes

$${‖ r - \sqrt{\frac{12 ρ}{m ( {Q}^{2} - 1 )}} \cdot H \cdot u ‖}^{2}$$

Eq. 5 for a receiving signal symbol r. That is, a soft output value may be obtained for each bit configuring a transmission symbol.

As shown in FIG. 1, the lattice point nearest to the receiving signal and having a symbol bit opposite to the maximum likelihood symbol for all bits of the receiving signal is calculated at step S102.

Then, a ratio of the distance from the receiving signal to the maximum likelihood symbol obtained at the step S101 and other distance from the receiving signal to the lattice point calculated at the step S102 is calculated from each of bits at step S103. Then, the calculated ratio is inputted to a channel decoder.

Hereinafter, a second algorithm 2 used at the step S102 for calculating the lattice points nearest to the receiving signal and having a symbol bit opposite to the maximum likelihood symbol for all bits of the receiving signal will be described.

The second algorithm 2 receives an m x m upper triangular matrix H, m-order vectors rεR^{m} and m-order maximum likelihood vectors û^{ml}εX^{m}. Also, the second algorithm 2 outputs m-order vectors having

Hûᵢ^{j}

nearest to r and has a j^{th} bit of i^{th} row element different from û^{ml}

$${\hat{u}}_{i}^{j} = [ \begin{matrix}{u}_{1} ∈ X \\ ⋮ \\ {u}_{i} ∈ {X}_{j} ( {u}_{i}^{m 1 j} ) \\ ⋮ \\ {u}_{m} ∈ X\end{matrix} ]$$

Herein, Xⱼ(i)⊂X denotes a set of signal points having a j^{th} bit different from i.

```
  1. m = an order of H
  2. bestdist(shortest distance) = 8
  3. k=m
  4. distₘ (distance of m-order)= 0
  5. eₘ =r
  6.
if m == i then uₘ = [symbol] eₘₘ/hₘₘ [symbol] _{X}_{ⱼ}₍ᵤ_{^{m/j}}_{ᵢ}₎
  7. else uₘ= [symbol] eₘₘ/hₘₘ [symbol] ₓ
  8. y=eₘ − hₘₘuₘ
  9. stepₘ = 2sgn*(y)
  10. <loop>
  11. newdist = distₖ + y²
  12. if k=i if newdist< betdist and uₖ ∈Xⱼ(u^{mlj}ᵢ) then{
  13. else if newdist < bestdist and uₘ?X then {
  14. if k?1 then {
  15. e_{k-1,i}=eₖᵢ − hᵢₖuₖ for i=1,...k−1
  16. k=k−1
  17. distₖ = newdist
  18.
if k == i then uₘ = [symbol] eₘₘ/hₘₘ [symbol] _{X}_{ⱼ}₍ᵤ_{^{m/j}}_{ᵢ}₎
  19. else uₖ= [symbol] eₖₖ/hₖₖ [symbol] ₓ
  20. y=eₖₖ − hₖₖuₖ
  21. stepₖ = 2sgn*(y)
  22. } else {
  23 u\hat{ }=u
  24. bestdist = newdist
  25. k=k+1
  26. uₖ = uₖ + stepₖ
  27. y=eₖₖ − hₖₖuₖ
  28. stepₖ = −stepₖ + 2sgn*(stepₖ)
  29. }
  30. } else if newdist < bestdist then {
  31. uₖ = uₖ + stepₖ
  32. y=eₖₖ − hₖₖuₖ
  33. stepₖ = −stepₖ + 2sgn*(stepₖ)
  34. } else {
  35. if k=n then return u\hat{ }(and exit)
  36. else {
  37. k=k+1
  38. uₖ = uₖ + stepₖ
  39. y=eₖₖ − hₖₖuₖ
  40. stepₖ = −stepₖ + 2sgn*(stepₖ)
  41. }
  42. }
  43. goto <loop>
```

FIG. 2 is a flowchart showing a soft output sphere decoding method in accordance with another embodiment of the present invention.

As shown in FIG. 2, a maximum likelihood symbol nearest to the receiving signal is obtained using a conventional sphere decoding algorithm at step S201. Since the step S201 is identical to the step S101 in FIG. 1, the detail description thereof is omitted.

At step S202, a lattice point nearest to the receiving signal having a predetermined portion of symbol bits identical to the maximum likelihood symbol and a remained portion of symbol bits opposite to the maximum likelihood symbol is calculated for all of the bits.

Then, a ratio between a distance from the receiving signal to the maximum likelihood symbol obtained at step S201 and other distance from the receiving signal to the lattice points calculated at step S202 is calculated at step S203. Then, the calculated ratio is inputted to a channel decoder.

Hereinafter, a third algorithm 3 used in the step S202 for calculating the lattice point having a predetermined portion of symbol bits identical to the maximum likelihood symbol and a remained portion of symbol bits opposite to the maximum likelihood symbol will be described.

The third algorithm 3 receives an m×m triangular matrix H, m-order vectors rεR^{m} and m-order maximum likelihood vectors û^{ml}εX^{m}.

Also, the third algorithm 3 outputs m-order vectors

$${{u}^{\vert}}_{i}^{j}$$

having bits from (j−1)^{th} bit of an i^{th} column to an n^{th} column identical to û^{ml}, having a j^{th} bit of an i^{th} column different from û^{ml} and having

Hûᵢ^{j}

nearest to r.

$${\tilde{u}}_{i}^{j} = [ \begin{matrix}{u}_{1} ∈ X \\ ⋮ \\ {u}_{i - 1} ∈ X \\ {u}_{i} ∈ {\tilde{X}}_{j} ( {\hat{u}}_{i}^{ml} ) \\ {\hat{u}}_{i \vert 1}^{ml} \\ ⋮ \\ {\hat{u}}_{n}^{ml}\end{matrix} ]$$

1. m = order of H
2. bestdist(shortest distance) = 8
3. k=m
4. distₘ (distance of m-order)= 0
5. eₘ=r
6.

uₘ = ûₘ^{ml}

7. y=eₘ − hₘₘuₘ
8. while K > 1 {
9. newdist = distₖ + y²
10. e_{k-1,i}=eₖᵢ − hᵢₖuₖ for i=1,...K−1
11. k=k−1
12.

uₖ = ûₖ^{ml}

13. y=eₖ − hₖₖuₖ
14. }
15.

uₖ = [symbol] eₖₖ/hₖₖ [symbol] _{\ddot{X}}_{ⱼ}(ûₖ^{ml})

16. y=eₖₖ − hₖₖuₖ
17. stepₖ = 2sgn*(y)
18 <loop>
19. newdist = distₖ + y²
20. if newdist < bestdist then {
21. if k?1 then {
22. e_{k-1,i}=eₖᵢ − hᵢₖuₖ for i=1,...k−1
23. k=k−1
24. distₖ = newdist
25. uₖ = <eₖₖ/hₖₖ>ₓ
26. y=eₖₖ − hₖₖuₖ
27. stepₖ = 2sgn*(y)
28. } else {
29.

${\vert}_{{u}_{i}^{j}}$
= u

30. bestdist = newdist
31. if i==1 then return

${\vert}_{{u}_{i}^{j}}$
(and exit)

32. k=k+1
33. do{
34. uₖ = uₖ + stepₖ
35. stepₖ = −stepₖ + 2sgn*(stepₖ)
36. } while (if k==1 then

uₖ ∉ \tilde{X}ⱼ (ûᵢ^{ml}) else uₖ ∉ X
) and

37. |stepₖ| = 4(Q−1)
38. if |stepₖ| = 4(Q−1) then uₖ = 8
39. y=eₖₖ − hₖₖuₖ
40. }
41. } else {
42. if k==i then return

${\vert}_{{u}_{i}^{j}}$
(and exit)

43. else {
44. k=k+1
45. do {
46. uₖ = uₖ + stepₖ
47. stepₖ = −stepₖ + 2sgn*(stepₖ)
48. } while (if k==1 then

uₖ ∉ \tilde{X}ⱼ (ûᵢ^{ml}) else uₖ ∉ X
) and
49. |stepₖ| = 4(Q−1)
50. if |stepₖ| = 4(Q−1) then uₖ = 8
51. y=eₖₖ −hₖₖuₖ
52. }
53. }
54. goto <loop>

The methods according to the present invention can be embodied as a program and the program can be stored in a computer readable recording medium such as a compact disk read only memory (CD-ROM), a random access memory (RAM), a read only memory (ROM), a floppy disk, a hard disk and an optical magnetic disk.

The present application contains subject matter related to Korean patent application No. 2005-0051848, filed in the Korean Intellectual Property Office on Jun. 16, 2005, the entire contents of which is incorporated herein by reference.

While the present invention has been described with respect to certain preferred embodiments, it will be apparent to those skilled in the art that various changes and modifications may be made without departing from the scope of the invention as defined in the following claims.

1. A soft output sphere decoding method in a multiple input multiple output (MIMO) system comprising the steps of:
detecting a maximum likelihood symbol nearest to a receiving signal;
calculating a lattice point nearest to the receiving signal and having a symbol bit opposite to the detected maximum likelihood symbol for all bits of the receiving signal; and
calculating a ratio between a distance from the receiving signal to the detected maximum likelihood symbol and other distance from the receiving signal to the calculated lattice points for each bit.

2. A soft output sphere decoding method in a multiple input multiple output (MIMO) system comprising the steps of:
detecting a maximum likelihood symbol nearest to a receiving signal;
calculating a lattice point nearest to the receiving signal and having a predetermined portion of symbol bits identical to the detected maximum likelihood symbol and a remained portion of symbol bits opposite to the detected maximum likelihood symbol for all bits of the receiving signal; and
calculating a ratio between a distance from the receiving signal to the detected maximum likelihood symbol and other distance from the receiving signal to the calculated lattice points for each bit.
